(19) United States
(12) Patent Application Publication
(10) Pub. No.: US 2010/0150141 A1
(43) Pub. Date: Jun. 17, 2010

(54) METHOD AND APPARATUS FOR DETERMINING MEDIA CODEC IN SIP-BASED VOIP NETWORK

(75) Inventor: Ki-Sung LEE, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/638,307

(22) Filed: Dec. 15, 2009

(30) Foreign Application Priority Data
Dec. 16, 2008 (KR) 10-2008-0128092

(51) Int. Cl. H04L 12/66

(52) U.S. Cl. 370/352

(57) ABSTRACT

A method and apparatus for determining a media codec in a Session Initiation Protocol (SIP)-based Voice over Internet Protocol (VoIP) network are provided. The method includes determining an SIP entity to be assigned with a priority for determining the media codec, generating an SIP message including information on the SIP entity having the priority for determining the media codec, and transmitting the SIP message.

### PRIORITY

This application claims the benefit under 35 U.S.C. §119(a) of a Korean patent application filed in the Korean Intellectual Property Office on Dec. 16, 2008 and assigned Serial No. 10-2008-0128092, the entire disclosure of which is hereby incorporated by reference.

### BACKGROUND OF THE INVENTION

1. Field of the Invention

The present invention relates to a Session Initiation Protocol (SIP). More particularly, the present invention relates to a method and apparatus for determining a media codec in an SIP-based Voice over Internet Protocol (VoIP) network.

2. Description of the Related Art

A Voice over Internet Protocol (VoIP) supports voice communication using the Internet and is gaining acceptance as an alternative to a Public Switched Telephone Network (PSTN). A call processing technique and a real-time voice data transmission technique are required to provide a VoIP service. To propose a call processing standard, the International Telecommunication Union Telecommunication Standardization Sector (ITU-T) has defined the H.323 protocol and the Internet Engineering Task Force (IETF) has defined a Session Initiation Protocol (SIP). The H.323 is more complex than the SIP since the H.323 accepts several signals to provide compatibility, and has many restrictions on scalability in terms of adding new functions.

The SIP is a signaling protocol for creating, modifying, and releasing a multimedia session. The SIP uses a text-based encoding scheme such as a HyperText Transfer Protocol (HTTP). Therefore, there is an advantage in that the SIP can be easily developed with excellent scalability and flexibility.

An SIP message consists of a text-based header and body similar to the HTTP. Therefore, information (i.e., an IP address or port information) on a certain entity with respect to its peer entity and information on a call are described in the header of the SIP message, and such a description is configured by combining SIP headers. In addition, a part for indicating session information for multimedia exchange is described in the body of the SIP message according to a Session Description Protocol (SDP).

Among SIP entities, an offerer is an entity that describes and transmits an SDP to create or modify a session. The offerer transmits an SIP message (e.g., an INVITE message) to announce a codec list that can be used by an SIP entity. An SDP answerer is an SIP entity that receives the SIP message. The SDP answerer compares an available codec list with the received codec list to determine a codec to be used, and transmits the determined codec by using an SDP answer message (e.g., a 200 OK message).

FIG. 1 illustrates an example of creating a session in an SIP-based VoIP network according to the related art.

Referring to FIG. 1, in order to create or modify the session, an SDP offerer 100 (e.g., an SIP server, an Internet phone, etc.) generates and transmits to an SDP answerer 110 an INVITE message 105 including information in which codecs A, B, and C are prioritized in that order. The SDP answerer 110 receives the INVITE message 105. Thereafter, if codecs D, C, and B prioritized in that order are supported by the SIP entity, the SDP answerer 110 determines any one of codecs B and C matched to those of the supported codecs, generates a 200 OK message 115 including information on the determined codec, and transmits the 200 OK message 115 to the SDP offerer 100.

However, even if the codec needs to be determined based on priorities of codecs supported by the SIP entity that transmits an SDP offer message (e.g., the INVITE message 105), the codec is arbitrarily determined by the SIP entity that transmits an SDP answer message (e.g., the INVITE message 115), and this problem cannot be solved in the related art.

### SUMMARY OF THE INVENTION

An aspect of the present invention is to address at least the above-mentioned problems and/or disadvantages and to provide at least the advantages described below. Accordingly, an aspect of the present invention is to provide a method and apparatus for determining a media codec in a Session Initiation Protocol (SIP)-based Voice over Internet Protocol (VoIP) network.

Another aspect of the present invention is to provide a method and apparatus for determining a codec to be used according to priorities of codecs supported by an SIP entity that transmits a Session Description Protocol (SDP) offer message in an SIP-based VoIP network

In accordance with an aspect of the present invention, a method of determining a media codec in an SIP-based VoIP network is provided. The method includes determining an SIP entity to be assigned with a priority for determining the media codec, generating an SIP message including information on the SIP entity having the priority for determining the media codec, and transmitting the SIP message.

In accordance with another aspect of the present invention, a method of determining a media codec in an SIP-based VoIP is provided. The method includes receiving an SIP message including information on an SIP entity having a priority for determining the media codec, determining a codec to be used according to the SIP entity having the priority for determining the media codec, generating another SIP message including information on the determined codec, and transmitting the other SIP message including the information on the determined codec.

In accordance with another aspect of the present invention, a system for determining a media codec in an SIP-based VoIP is provided. The system includes an SDP offerer for determining an SIP entity to be assigned with a priority for determining the media codec, for generating an SIP message including information on the SIP entity having the priority for determining the media codec, and for transmitting the SIP message, and an SDP answerer for receiving the SIP message including the information on the SIP entity having the priority for determining the media codec, for determining a codec to be used according to the SIP entity having the priority, for generating another SIP message including information on the determined codec, and for transmitting the other SIP message including the information on the determined codec.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates an example of creating a session in a Session Initiation Protocol (SIP)-based Voice over Internet Protocol (VoIP) network according to the related art;

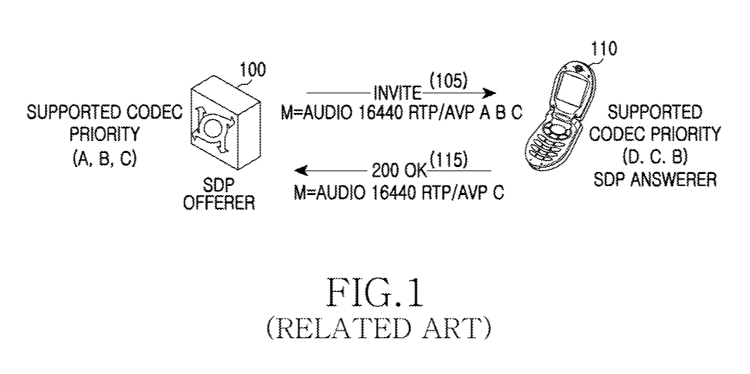

FIG. 2 illustrates an example of creating a session in an SIP-based VoIP network according to an exemplary embodiment of the present invention;

FIG. 3 illustrates another example of creating a session in an SIP-based VoIP network according to an exemplary embodiment of the present invention;

FIG. 4 illustrates an example of modifying a session in an SIP-based VoIP network according to an exemplary embodiment of the present invention;

FIG. 5 is a flowchart illustrating an operation of a Session Description Protocol (SDP) offerer for creating a session in an SIP-based VoIP network according to an exemplary embodiment of the present invention; and

FIG. 6 is a flowchart illustrating an operation of an SDP answerer for creating a session in an SIP-based VoIP network according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, an exemplary method and apparatus for determining a media codec in a Session Initiation Protocol (SIP)-based Voice over Internet Protocol (VoIP) network will be described.

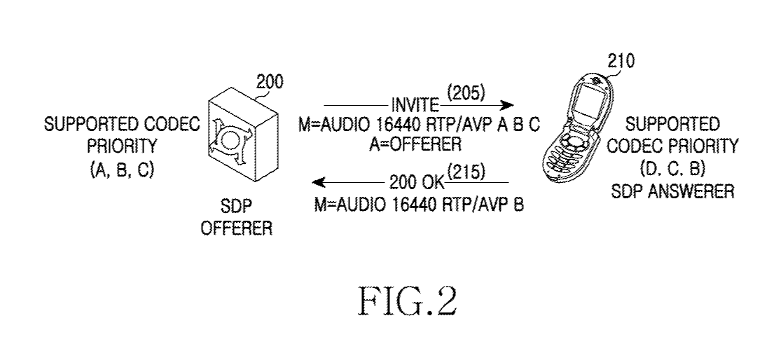

FIG. 2 illustrates an example of creating a session in an SIP-based VoIP network according to an exemplary embodiment of the present invention.

Referring to FIG. 2, in order to create the session, an SDP offerer 200 (e.g., an SIP server, an Internet phone, etc.) generates and transmits to an SDP answerer 210 an INVITE message 205 including information on codecs A, B, and C, prioritized in that order. The INVITE message 205 also includes an identifier that indicates that the SDP offerer 200 has a codec selection priority. The inclusion of the identifier in INVITE message 205 that indicates that the SDP offerer 200 has a codec selection priority will be described below.

The INVITE message 205 is divided into a header part and a body part. The body part is described with a Session Description Protocol (SDP).

The SDP is a format for describing session information. The SDP transmits information on a media stream in a multimedia session, and is configured in a text format of <type>=<value>. In the SDP, the session information is described with a session descriptor, a media descriptor, and a time descriptor.

The session descriptor applies to the SDP session and the media stream, and starts with “v=”. The media descriptor applies to one media stream, and starts with “m=”. The time descriptor describes a time period in which a session is maintained (e.g., a start time and an end time), and starts with “t=”.

For example, if the media descriptor is described with “m=audio 16440 RTP/AVP A B C”, “m=” indicates that it is the media descriptor, “audio” indicates that a media type is audio, “16440” is a port number by which a media stream is transmitted, “RTP” indicates that a Real-Time Transport Protocol (RTP) is used as a transport protocol, and “AVP A B C” specifies a media format and indicates that codecs A, B, and C are used and prioritized in that order. Examples of the media type include “audio”, “video”, “application”, “data”, “control”, etc. In addition thereto, when the INVITE message 205 is generated, the INVITE message 205 includes an identifier that indicates that the SDP offerer 200 has a codec selection priority in the field (a) of the INVITE message 205. The “a=” is used when session information is extended in the session descriptor, the media descriptor, and the time descriptor. Therefore, in a case where a codec is determined based on a codec priority of the SDP offerer, the identifier is described with “a=offerer” when included.

The SDP answerer 210 receives the INVITE message 205 including an identifier that indicates that the SDP offerer 200 has the codec selection priority and information on codecs A, B, and C prioritized in that order by the SDP offerer 200. Thereafter, if codecs D, C, and B prioritized in that order are supported by the SDP answerer 210, the SDP answerer 210 determines the codec B between codecs B and C matched to those of the supported codecs, according to a criterion of the SDP offerer 200 having the codec selection priority, generates a 200 OK message 215 including information on the determined codec B, and transmits the 200 OK message 215 to the SDP offerer 200.

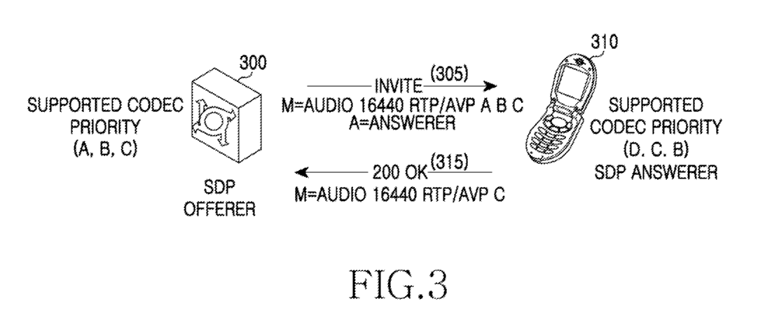

FIG. 3 illustrates another example of creating a session in an SIP-based VoIP network according to an exemplary embodiment of the present invention.

Referring to FIG. 3, in order to create the session, an SDP offerer 300 generates an INVITE message 305 including information on codecs A, B, and C, prioritized in that order by the SDP offerer 300. The SDP offerer 300 then transmits the INVITE message 305 to the SDP answerer 310. A body part of the INVITE message 305 is described with “m=audio 16440 RTP/AVP A B C” similar to the INVITE message 205 of FIG. 2.

As described above with reference to FIG. 2, the identifier indicating the entity having the codec selection priority is described with “a=offerer” when included in the field (a) of the INVITE message 205 in a case where a codec is determined based on the codec priority of the SDP offerer 200.

In contrast, in FIG. 3, the identifier indicating the entity having the codec selection priority is described with “a=answerer” when included in a field (a) of the INVITE message 305 in a case where a codec is determined based on a codec priority of the SDP answerer 310. If the priority is meaningless, the identifier is not used, similar to the method of the related art.

The SDP answerer 310 receives the INVITE message 305 including the identifier indicating that the SDP answerer 310 has the codec selection priority and information on codecs A, B, and C prioritized in that order by the SDP offerer 300. Thereafter, if codecs D, C, and B prioritized in that order are supported by the SDP answerer 310, the SDP answerer 310 determines the codec C between codecs B and C matched to those of the supported codecs according to a criterion of the SDP answerer 310 having the codec selection priority, generates a 200 OK message 315 including information on the determined codec C, and transmits the 200 OK message 315 to the SDP offerer 300.

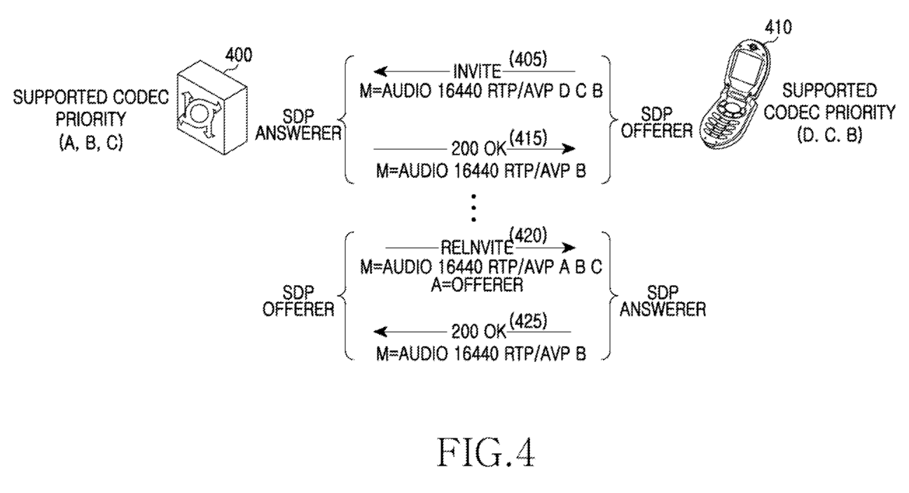

FIG. 4 illustrates an example of modifying a session in an SIP-based VoIP network according to an exemplary embodiment of the present invention.

Referring to FIG. 4, an SDP offerer 410 generates an INVITE message 405 including an identifier that indicates that the SDP offerer 410 has the codec selection priority and information on codecs D, C, and B, prioritized in that order by the SDP offerer 410. The SDP offerer 410 then transmits the INVITE message 405 to an SDP answerer 400. The SDP answerer 400 receives the INVITE message 405. Thereafter, if codecs A, B, and C prioritized in that order are supported by the SDP answerer 400, the SDP answerer 400 determines the codec B between codecs B and C matched to those of the supported codecs, generates a 200 OK message 415 including information on the determined codec B, and transmits the 200 OK message 415 to the SDP offerer 410.

After the codec B is determined for an initial call connection, when a session needs to be modified due to an additional service or the like, the SDP offerer 400 (which initially served as an SDP answerer and later serves as an SDP offerer when providing an SDP to modify a session) generates a reINVITE message 420 including an identifier that indicates that the SDP offerer 400 has the codec selection priority and information on codecs A, B, and C, prioritized in that order by SDP offerer 400. The SDP offerer 400 then transmits the reINVITE message 420 to the SDP answerer 410.

An identifier indicating an entity having a codec selection priority is described with “a=offerer” when included in a field (a) of the INVITE message 420 in a case where a codec is determined based on a codec priority of the SDP offerer 400.

The SDP answerer 410 receives the reINVITE message 420 including the identifier indicating that the SDP offerer 400 has the codec selection priority and information on codecs A, B, and C prioritized in that order by the SDP offerer 400. Thereafter, if codecs D, C, and B prioritized in that order are supported by SDP answerer 410, the SDP answerer 410 determines the codec B between codecs B and C matched to those of the supported codecs according to a criterion of the SDP offerer 400 having the codec selection priority, generates a 200 OK message 425 including information on the determined codec B, and transmits the 200 OK message 425 to the SDP offerer 400.

Therefore, when transmitting the reINVITE message 420 or the like, a codec can be prevented from modification or a call can be prevented from being disconnected from an SIP entity not supporting modification of the codec. When the codec is modified during an actual call, resources of the SIP entity may be wasted. If the method according to the related art is used instead of using the method proposed in exemplary embodiments of the present invention, a codec determined using the reINVITE message 420 is not the codec B but the codec C, and thus codec modification occurs in two SIP entities. If the SIP entity does not support codec modification, “488 Not Acceptable Here” may be sent as an answer, and then the call may be released.

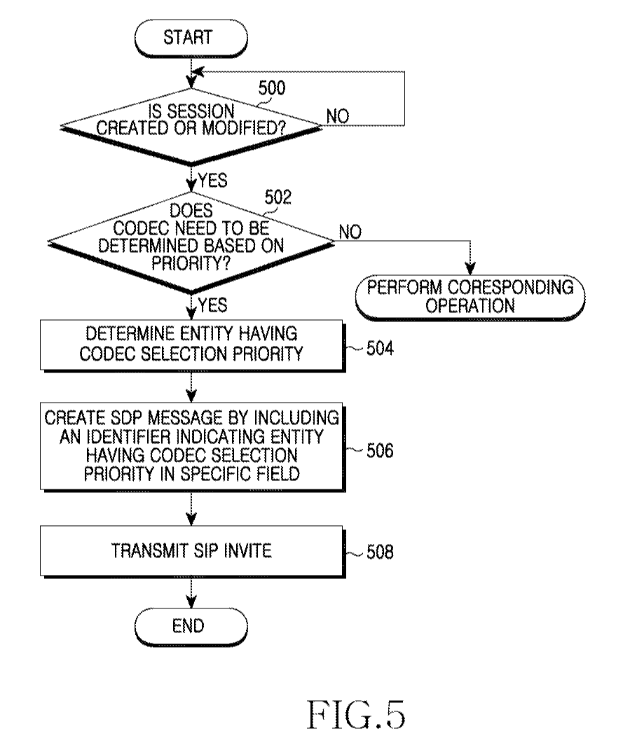

FIG. 5 is a flowchart illustrating an operation of an SDP offerer for creating a session in an SIP-based VoIP network according to an exemplary embodiment of the present invention.

Referring to FIG. 5, when the session is created or modified in step 500, the SDP offerer determines whether there is a need to determine a codec by assigning a priority to an SIP entity (i.e., an SDP offerer or an SDP answerer) in step 502.

If the SDP offerer determines in step 502 that the codec needs to be determined by assigning the priority to the SIP entity, the procedure proceeds to step 504. Otherwise, if the codec is not determined by assigning the priority, a corresponding operation is performed.

In step 504, the SDP offerer determines the SIP entity (i.e., the SDP offerer or the SDP answerer) to which the priority is assigned.

In step 506, the SDP offerer describes an SDP by including an identifier, indicating an entity having the codec selection priority, in a specific field.

For example, as shown in FIG. 2, if the codec selection priority is assigned to the SIP entity transmitting an SDP offer message, the SDP offer message is generated by including “offerer” in field (a) of an SDP offer message. Alternatively, if the codec selection priority is assigned to an SIP entity receiving the SDP offer message, the SDP is described by including “answerer” in the field (a) of the SDP.

In step 508, the SDP offerer transmits the described SDP by using an SIP INVITE message.

Thereafter, the procedure of FIG. 5 ends.

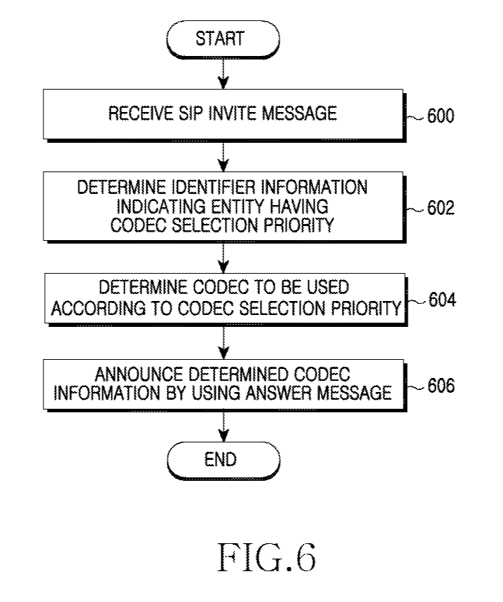

FIG. 6 is a flowchart illustrating an operation of an SDP answerer for creating a session in an SIP-based VoIP network according to an exemplary embodiment of the present invention.

Referring to FIG. 6, the SDP answerer receives an SIP INVITE message in step 600. In step 602, the SDP answerer confirms identifier information indicating an entity having a codec selection priority described in a body part of the SIP INVITE message, and thus determines whether an SIP entity having the codec selection priority is the SDP answerer or an SDP offerer.

In step 604, the SDP answerer determines a codec to be used according to the codec selection priority. For example, as shown in FIG. 2, in a case where a field (m) for indicating a codec priority of the SDP offerer is “m=audio 16440 RTP/AVP A B C” and codecs D, C, and B are prioritized in that order, the SDP answerer determines the codec B if the field (a) is described with “a=offerer”. Otherwise, if the field (a) is described with “a=answerer”, the SDP answerer determines the codec C.

In step 606, the SDP answerer announces the determined codec information to the SDP offerer by using an answer message.

Thereafter, the procedure of FIG. 6 ends.

According to exemplary embodiments of the present invention, an SDP offer message is transmitted by including an identifier for indicating a codec selection priority in an SIP-based VoIP network, and thus a codec can be determined based on a codec priority of an SDP offerer or an SDP answerer. In addition, when the codec is determined through initial session creation, in a situation where a session needs to be modified due to an additional service or the like, the codec can be prevented from modification, or a call can be prevented from being disconnected from an SIP entity not supporting the modified codec.

While the present invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method of determining a media codec in a Session Initiation Protocol (SIP)-based Voice over Internet Protocol (VoIP) network, the method comprising:
determining an SIP entity to be assigned with a priority for determining the media codec;
generating an SIP message including information on the SIP entity having the priority for determining the media codec; and
transmitting the SIP message.

2. The method of claim 1, wherein the information on the SIP entity having the priority for determining the media codec is described using a Session Description Protocol (SDP).

3. The method of claim 2, wherein the information on the SIP entity having the priority for determining the media codec is included in an extension field (a) of the SDP in a format of one of “a=offerer” and “a=answerer”.

4. The method of claim 1, wherein the SIP message is one of an INVITE message and a reINVITE message.

5. The method of claim 1, further comprising receiving another SIP message including information on a codec to be used according to the SIP entity having the priority for determining the media codec.

6. The method of claim 1, wherein the other SIP message is a 200 OK message.

7. The method of claim 1, wherein the SIP message includes information on an order of priority of one or more codecs.

8. A method of determining a media codec in a Session Initiation Protocol (SIP)-based Voice over Internet Protocol (VoIP), the method comprising:
receiving an SIP message including information on an SIP entity having a priority for determining the media codec;
determining a codec to be used according to the SIP entity having the priority for determining the media codec;
generating another SIP message including information on the determined codec; and
transmitting the other SIP message including the information on the determined codec.

9. The method of claim 8, wherein the information on the SIP entity having the priority for determining the media codec is described using a Session Description Protocol (SDP).

10. The method of claim 9, wherein the information on the SIP entity having the priority for determining the media codec is included in an extension field (a) of the SDP in a format of one of “a=offerer” and “a=answerer”.

11. The method of claim 8, wherein the SIP message is one of an INVITE message and a reINVITE message.

12. The method of claim 8, wherein the SIP message includes information on an order of priority of one or more codecs.

13. The method of claim 8, wherein the other SIP message is a 200 OK message.

14. The method of claim 8, wherein the determining of the codec to be used comprises determining the codec to be used according to the SIP entity having the priority for determining the media codec, the information included in the SIP message on an order of priority of first one or more codecs, and an order of priority of second one or more codecs.

15. A system for determining a media codec in a Session Initiation Protocol (SIP)-based Voice over Internet Protocol (VoIP), the system comprising:
a Session Description Protocol (SDP) offerer for determining an SIP entity to be assigned with a priority for determining the media codec, for generating an SIP message including information on the SIP entity having the priority for determining the media codec, and for transmitting the SIP message; and
an SDP answerer for receiving the SIP message including the information on the SIP entity having the priority for determining the media codec, for determining a codec to be used according to the SIP entity having the priority, for generating another SIP message including information on the determined codec, and for transmitting the other SIP message including the information on the determined codec.

16. The system of claim 15, wherein the information on the SIP entity having the priority for determining the media codec is described using an SDP.

17. The system of claim 16, wherein the information on the SIP entity having the priority for determining the media codec is included in an extension field (a) of the SDP in a format of one of “a=offerer” and “a=answerer”.

18. The system of claim 15, wherein the SIP message is one of an INVITE message and a reINVITE message.

19. The system of claim 15, wherein the SIP message includes information on an order of priority of one or more codecs supported by the SDP offerer.

20. The system of claim 15, wherein the other SIP message is a 200 OK message.

21. The system of claim 15, wherein the SDP offerer receives the other SIP message including the information on the determined codec.

22. The system of claim 15, wherein the determining, by the SDP answerer, of the codec to be used comprises determining the codec to be used according to the SIP entity having the priority for determining the media codec, the information included in the SIP message on an order of priority of one or more codecs supported by the SDP offerer, and an order of priority of one or more codecs supported by the SDP answerer.
